(19) United States
(12) Patent Application Publication
(10) Pub. No.: US 2016/0125701 A1
(43) Pub. Date: May 5, 2016

(54) ELECTRONIC CASINO GAME

(71) Applicant: Donald E. Buza, Ortonville, MI (US)

(72) Inventor: Donald E. Buza, Ortonville, MI (US)

(21) Appl. No.: 14/533,845

(22) Filed: Nov. 5, 2014

(51) Int. Cl. G07F 17/32

(52) U.S. Cl. CPC G07F 17/3293; G07F 17/3244; G07F 17/3209; G07F 17/3211

(57) ABSTRACT

A system and method of the inventive concept presents an electronic casino game and a mobile application. The game consists of multiple rounds and a player can wager and win on individual rounds or multiple rounds to make a “poker” hand. Additionally, there may be a progressive jackpot offered on the “poker” hands for players to wager upon.

### FIELD OF INVENTION

This invention pertains generally to the field of card and table based casino electronic game and mobile applications, and more particularly to a method, apparatus, and computer readable storage medium directed to a card and table game.

### BACKGROUND OF THE INVENTION

Casinos become more popular as years go by. Casinos try to compete with one another to attract attention of patrons. The casinos who have most exciting games will prevail because these games of chance will keep the patrons entertained and increase the choices and diversity of the games of chance located on the casino floors. There are several casino style games of chance that have been played for many years, such as Roulette, Black Jack, and Poker in limited forms. There have also been some recent inventive activities to find that one game which can find its place in the hearts of gamblers. The latter include game such as Black Jack, Roulette, Craps and Baccarat. Many of these games have evolved elaborate conventions, which whilst well understood by experienced players, are intimidating to new table game players. Further, these games have rules, which may be simple once understood, but take some time to learn. For many players there is a fear that they will make a mistake and either appear foolish to the other players and staff, or lose their money unnecessarily. As a result, many players only play electronic gaming machines, as they can make a mistake without embarrassment.

The art is replete with various prior art references teaching different table games and methods. U.S. Pat. No. 4,006,906 to Gruber discloses a specific game using a 121-card deck that seems to separate color and suit. However, nothing in the patent specifies that suit, color, and rank must be genuinely independent, and their exact relationship remains obscure. The deck is much too large for general use, and most standard games have no need of the patented game's implied restrictions on suit symbols.

U.S. Pat. No. 5,887,873 to Freeman teaches a game that includes a deck of cards, tiles, or similar playing pieces, real or simulated on a computer or other device, chiefly characterized by a trilateral organization comprising three independent aspects: suit, value, and color or color group. The plurality of cards representing each element of each aspect comprise approximately equal pluralities of each element of each of the other aspects. Except for auxiliary cards, each card in a single deck represents a unique combination of a single suit, a single color group, and a single value or rank. The preferred form of the invention is a series of related triadic decks of playing cards comprising three suits and three color groups, nonsexist or gender-neutral picture cards, an improved layout, and indicative card backs. The layout improvement typically involves additional set designation markers in the two commonly vacant corners of a card face. Backs are uniform for all cards in a deck but different from deck to deck; the use of the elements of the back is sufficient to remind a player of the general configuration of the deck being used.

United States Patent Publication No. 20010015529 to Allen teaches a method for playing the casino game utilizing playing cards. The player makes at least one of the following wagers, a card value and suit, excluding Kings a suit, a suit color, and/or groups of card values and suits. From a standard deck of playing cards or preferably a standard deck of fifty-two cards with an additional Joker, a non-King playing card is randomly selected as the table card. If the table card does not correspond to any card value and/or suit or suit color wagered upon by the player, the players wager is lost and if the table card corresponds to a card value and/or suit or suit color wagered upon by the player, the player is paid an amount based upon his wager.

United States Patent Publication No. 20040066001 to Duncombe et al. teaches a method of operating a casino card game. The game is played with one or more decks of cards. The game includes a playing surface includes first marked areas for placing wagers on one or more aspects of the face value of a single card. A second marked area for placing wagers on one or more aspects of the face values of a plurality of successively dealt single cards. The method permits the players to place wagers in the first and second marked areas. Then the dealer deals a single card. The dealer collects and pays the wagers placed in the first marked area according to the face value of the single card. The game permits the players to place new wagers in the first marked areas.

United States Patent Publication No. 20120238343 to Perrone et al., teaches a method to implement a roulette game that uses five (or any other number) wheels. A player can make individual bets on each of the individual wheels at the player's discretion, and when the player is done allocating his or her individual bets then the player spins the five wheels. After the wheels stop spinning, all of the player's bets on the table are resolved based on whether the bet is a winner for that particular wheel. Chips and wheels can be color (or pattern) coded so that chips appear differently depending on which roulette wheel those chips are being bet on. Chips that match the color (or pattern) of one the roulette wheels are associated with that wheel, and thus only the results of that particular roulette wheel matter to the resolution of the bet for that chip

There is a longstanding need and opportunity for new electronic games that will be easy to learn, fun to play, and more over will be exciting and attract attention of new patrons thereby generating revenue for the casinos.

There is another longstanding need and opportunity for applications for electronic games that can be used on mobile applications that will be easy to learn, fun to play, and more over will be exciting and attract attention of new users.

### SUMMARY OF THE INVENTION

An electronic gaming apparatus of the present invention includes a machine-readable medium having computer program code stored thereon which when executed by a machine causes the machine to perform a method of conducting an electronic game variation between users. The electronic gaming apparatus includes a user interface component, a controller of the electronic gaming apparatus performing dealer functions, and a first device connected to the controller to generate a first image element representing a table surface of a first color presenting a dealer section and players section.

The apparatus further includes a second device connected to the controller to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections.

The apparatus further includes a third device connected to the controller to generate a third image element representing a second of the sections extending from the first section presenting color identifiers allowing the players to place the bets on any of the color identifiers. Alluding to the above, the apparatus includes a fourth device connected to the controller to generate a forth image element representing a third of the sections extending from the first section presenting kind identifiers of various colors allowing the players to place the bets on any of the kind identifiers.

The apparatus includes a fifth device connected to the controller to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device is connected to the controller is used to generate a sixth image element representing a card section having a plurality of segment wherein the number of the segment equals to the number of gaming rounds played by the players to allow a dealer to place the cards on each of the segments. A central processing unit is operably communicated with the controller for receiving information from the first device, the second device, the third device, the fourth device, the fifth device, and the sixth device to determine correlation between the first image elements through the fifth image elements presented to the users through the user interface component.

A software of the central processing unit is configured to calculate a plurality of winning options with each of the winning options presenting different winning combination values with the wagering section allowing the controller performing dealer functions to determine the winning outcome of each round as the controller performing dealer functions opens a card placed in order to each of the segments of the card section and determining a winner of a jackpot after all cards placed on each of the segments define one of the winning options presenting different of winning combination values and the other of the side presenting the first color to match with the surface.

In alternative embodiment of the present invention, in invention, a computer program product for a mobile application for a mobile device is presented. The computer program product includes computer-readable program code. The computer-readable program code is executed in a tangible memory medium and is configured to perform an electronic game of the present invention. The computer program product comprising a user interface component, a controller performing dealer functions, and a first device connected to the controller to generate a first image element representing a table surface of a first color presenting a dealer section and players section.

The computer program product further includes a second device connected to the controller to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections.

The computer program product further includes a third device connected to the controller to generate a third image element representing a second of the sections extending from the first section presenting color identifiers allowing the players to place the bets on any of the color identifiers. Alluding to the above, the computer program product includes a fourth device connected to the controller to generate a forth image element representing a third of the sections extending from the first section presenting kind identifiers of various colors allowing the players to place the bets on any of the kind identifiers.

The computer program product includes a fifth device connected to the controller to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device connected to the controller is used to generate a sixth image element representing a card section having a plurality of segment wherein the number of the segment equals to the number of gaming rounds played by the players to allow a dealer to place the cards on each of the segments. A central processing unit is operably communicated with the controller for receiving information from the first device, the second device, the third device, the fourth device, the fifth device, and the sixth device to determine correlation between the first image elements through the fifth image elements presented to the users through the user interface component.

A software of the central processing unit is configured to calculate a plurality of winning options with each of the winning options presenting different winning combination values with the wagering section allowing the controller performing dealer functions to determine the winning outcome of each round as the controller performing dealer functions opens a card placed in order to each of the segments of the card section and determining a winner of a jackpot after all cards placed on each of the segments define one of the winning options presenting different of winning combination values and the other of the side presenting the first color to match with the surface.

An advantage of the present invention is to provide providing a new game of chance that incorporates the excitement of a traditional card game, while giving the patron a potential high payout from their wager and increasing the choices and diversity of games of chance.

Another advantage of the present invention is to provide a new game and a mobile application that will attract those who may be intimidated by existing table games.

Still another advantage of the present invention is to provide a new game and a mobile application that is easy to be explained to those who never played the games of chance.

Still another advantage of the present invention is to provide a new game and a mobile application wherein no elaborate strategies or systems need to be learned by the players to play and enjoy the game.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of a gaming machine;

FIG. 2 illustrates a schematic view of operating components of the gaming machine;

FIG. 3 illustrates an enlarged fragmental view of a screen of the gaming machine of FIG. 1;

FIG. 4 illustrates a front view of a mobile phone with a screen showing a screenshot of a game of the present invention; and

FIG. 5 illustrates a schematic view of the gaming application of the present invention.

### DETAILED DESCRIPTION OF THE INVENTION

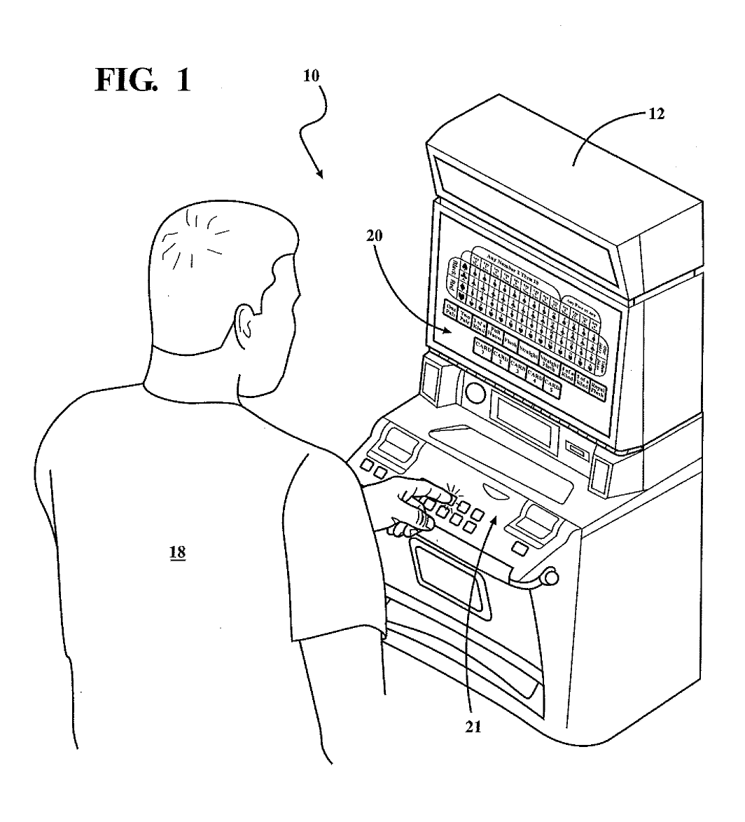

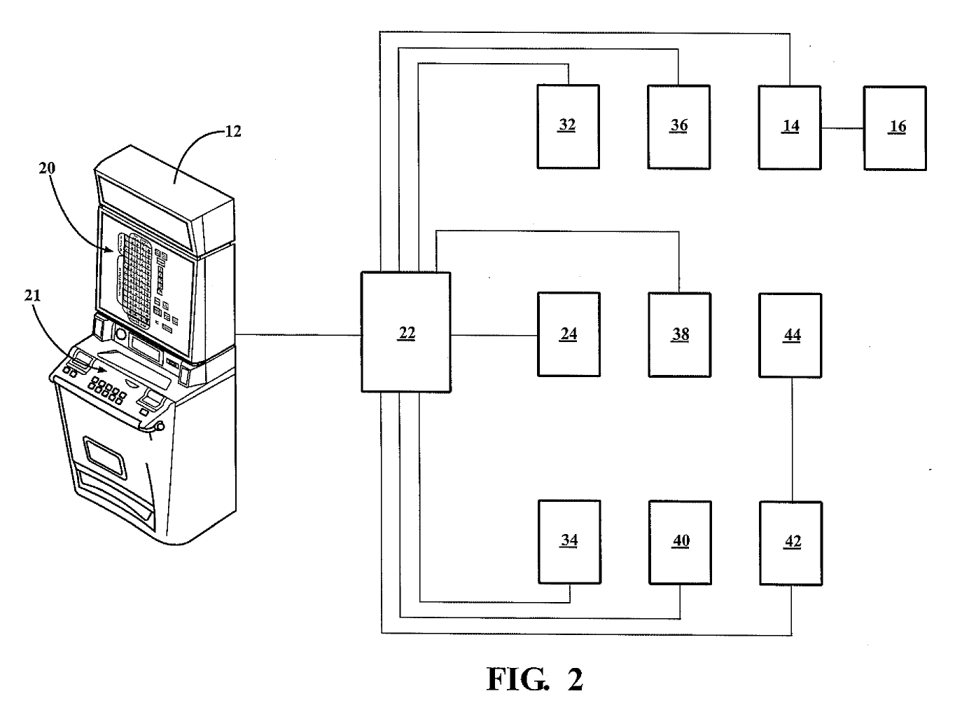

Referring to FIGS. 1 through 3, wherein like numerals indicate like or corresponding parts, an electronic gaming apparatus (the apparatus) of the present invention is generally shown at 10. The electronic gaming apparatus 10 is installed in a housing, generally indicated at 12, of the gaming apparatus 10. The apparatus 10 of the present invention includes a machine-readable medium 14 having a computer program code 16 stored thereon which when executed by a machine causes the machine to perform a method of conducting an electronic game variation between users, i.e. players 18. Only one user 18 is shown herewith but those skilled in the art will appreciate that the game can be played between multiple users playing at separate apparatuses 10 that are linked with one another through network. The electronic gaming apparatus 10 includes a user interface component, generally indicated at 20, such as a screen, allowing the user to play the electronic game, and key features, generally indicated at 21, allowing the user to insert money and press buttons to play the electronic game.

The electronic gaming apparatus 10 further includes a controller 22 allowing the apparatus 10 to perform various dealer functions and to receive information from the users 18 through the user personal devices such as, a mobile phone, a personal computer, and the like. A first device 24 is connected to the controller 22 to generate a first image element representing a table surface 26 of a first color presenting a dealer section 28 and a players section 30. The apparatus 10 further includes a second device 32 connected to the controller 22 to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections. The apparatus 10 further includes a third device 34 connected to the controller 22 to generate a third image element representing a second of the sections extending from the first section presenting color identifiers allowing the players to place the bets on any of the color identifiers.

Alluding to the above, the apparatus 10 includes a fourth device 36 connected to the controller 22 to generate a forth image element representing a third of the sections extending from the first section presenting kind identifiers of various colors allowing the players to place the bets on any of the kind identifiers. The apparatus 10 includes a fifth device 38 connected to the controller 22 to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device 40 is connected to the controller 22 is used to generate a sixth image element representing a card section having a plurality of segment wherein the number of the segment equals to the number of gaming rounds played by the players to allow a dealer to place the cards on each of the segments. A central processing unit 42 is operably communicated with the controller 22 for receiving information from the first device 24, the second device 32, the third device 34, the fourth device 36, the fifth device 38, and the sixth device 40 to determine correlation between the first image elements through the fifth image elements presented to the users through the user interface component 20.

A software 44 of the central processing unit 42 is configured to calculate a plurality of winning options with each of the winning options presenting different winning combination values with the wagering section allowing the controller 22 performing dealer functions to determine the winning outcome of each round as the controller 22 performing dealer functions opens a card placed in order to each of the segments of the card section and determining a winner of a jackpot after all cards placed on each of the segments define one of the winning options presenting different of winning combination values. The first area or playing field is generally indicated at 116. The first area 116 presents a plurality of rows generally indicated at 118, 120, 122, and 124. Preferable there are four rows. The number of rows is not intended to limit the scope of the present invention. Each row 118 through 124 is divided to a multitude of cells (only one of the cells is shown as generally indicated at 126). Each cell 126 includes an image of a card having the same suit, such as Spade, as shown at 128.

The cards range from Ace, as shown at 130, to 2, as shown at 132, with Ace being the first card located in an upper section and 2 being the last card located in a bottom section. The remaining three rows have three suits such as Clubs, shown at 134, Diamonds, shown at 136, and Hearts, shown at 138. These three rows 120, 122, and 124 also have cells 126 ranging from Ace to 2, i.e. Ace, King, Quinn, Knight, 10, 9, 8, 7, 6, 5, 4, 3, and 2. All cells 126 of all four rows 118, 120, 122, and 124 that contain Aces define an upper line 140 of the first area 116. All sections that contain “2” define a lower line 142 of the first area 116. The upper and lower lines 140 and 142 and spaced by side lines 144 and 146.

One of the side lines 144 faces a dealer station 150 and the other side line 146 faces player locations 152. A color section 154 extends from the lower line 142. The color section 154 is divided into two sectors, such as “Red” 156 and “Black” 158. A Joker section 160 extends from the upper line 140. The Joker section 160 is divided into “Blue Joker” and Yellow Joker” sections. The side line 146 further extends to a third section, generally indicated at 162 extending from the upper line 140 to the lower line 142 thereby adding another cell (only one is generally indicated at 166) to each cell 126 of the four rows 118, 120, 122, and 124 having different suits. Each cell 166 of the third section 162 has value of any of kind of cards located in these four rows 118, 120, 122, and 124.

For example, if the cell 66 of the third section 162 is adjacent the rows of these four rows having “Aces” of different suits such as Spade, Clubs, Diamonds, and Hearts, then the cell 166 of the third section 162 will say “Any of Ace”. The fourth section, generally indicated at 170, extends from the third section 162. The fourth section 170 is divided into two parts 172 and 174. One part 172 is called “Any face or Ace” and the other part 174 is called “Any number 2 through 10”.

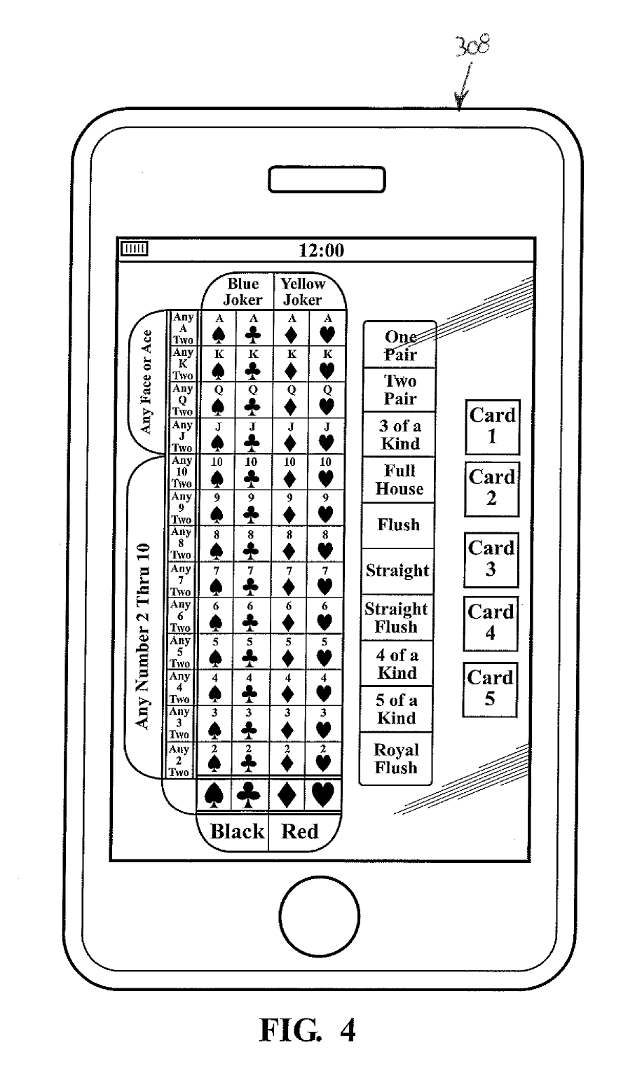

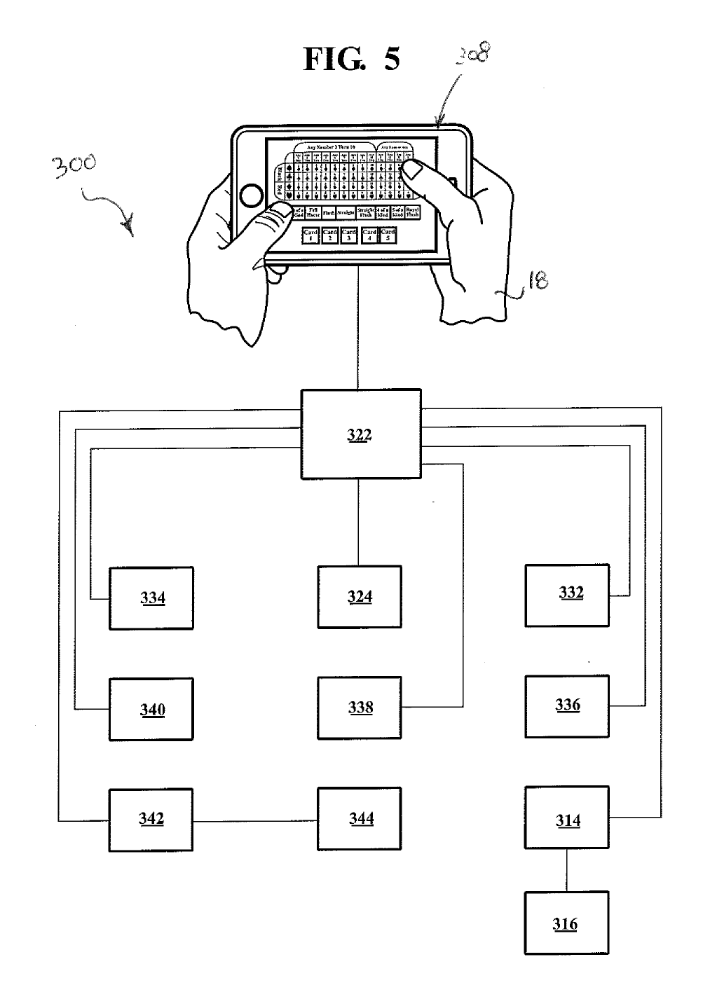

Referring to FIGS. 4 and 5, an alternative embodiment of the present invention, is shown at 300, and is directed a computer program product for a mobile application for a mobile device, such as a cell phone, generally indicated at 308, is presented. The computer program 342 product includes computer-readable program code 344. The computer-readable program code 344 is executed in a tangible memory medium and is configured to perform an electronic game of the present invention.

The computer program product comprises a user interface component, i.e. the cell phone 308, a controller 322 performing dealer functions, and a first device 324 connected to the controller 322 to generate a first image element representing a table surface of a first color presenting a dealer section and players section. The computer program product 342 further includes a second device 334 connected to the controller 322 to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections.

The computer program product 342 further includes a third device 332 connected to the controller 322 to generate a third image element representing a second of the sections extending from the first section presenting color identifiers allowing the players to place the bets on any of the color identifiers. Alluding to the above, the computer program product 342 includes a fourth device 338 connected to the controller 322 to generate a forth image element representing a third of the sections extending from the first section presenting kind identifiers of various colors allowing the players to place the bets on any of the kind identifiers. The computer program product 342 includes a fifth device 336 connected to the controller 322 to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device 340 connected to the controller 322 is used to generate a sixth image element representing a card section having a plurality of segment wherein the number of the segment equals to the number of gaming rounds played by the players to allow a dealer to place the cards on each of the segments. A central processing unit 314 is operably communicated with the controller 322 for receiving information from the first device, the second device, the third device, the fourth device, the fifth device, and the sixth device to determine correlation between the first image elements through the fifth image elements presented to the users through the user interface component.

A software 316 of the central processing unit 314 is configured to calculate a plurality of winning options with each of the winning options presenting different winning combination values with the wagering section allowing the controller 322 performing dealer functions to determine the winning outcome of each round as the controller 322 performing dealer functions opens a card placed in order to each of the segments of the card section and determining a winner of a jackpot after all cards placed on each of the segments define one of the winning options presenting different of winning combination values.

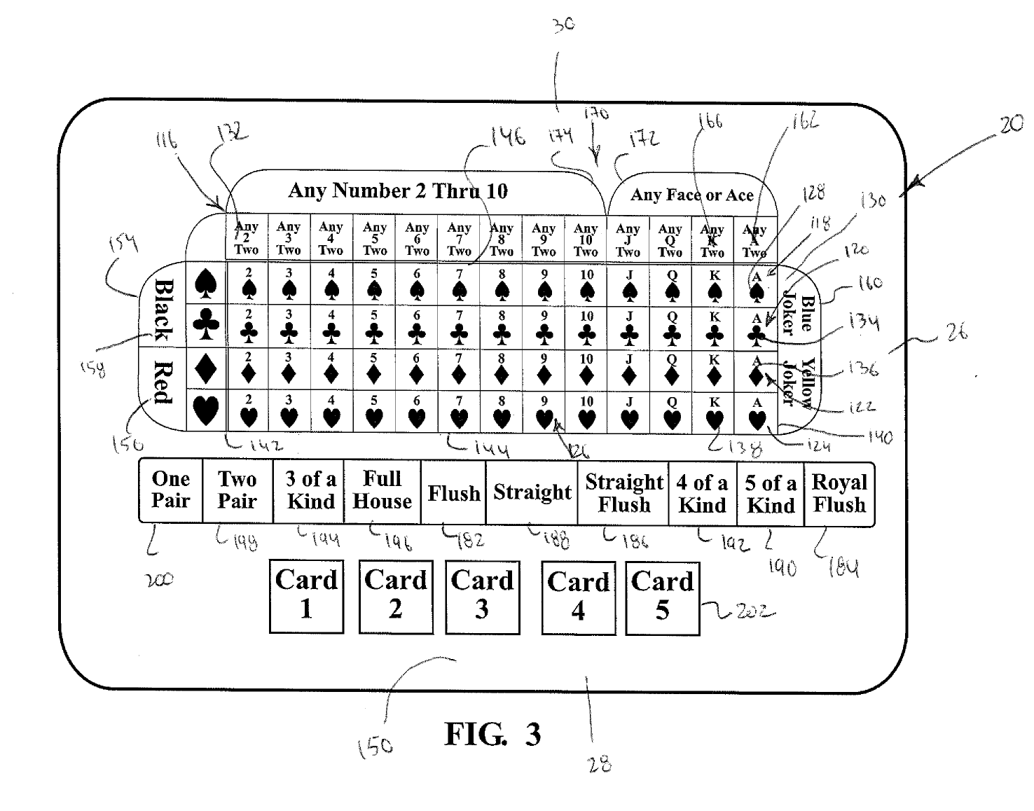

Referring back to FIG. 3, the payout section 180 includes a plurality of subsections that allow the players to place their bets. These subsections include a “Flush” subsection 182, a “Royal Flush” subsection 184, a “Straight Flush” subsection 186, a “Straight” subsection 188, a “5 of A Kind” subsection 190, a “4 of A Kind” subsection 192, a “3 of A Kind” subsection 194, a “Full House” subsection 196, a “Two Pairs” subsection 198, and a “One Pair” subsection 200. The payout section 180 also includes a five card segment that allows the dealer to deal five cards before the results of each game round are announced. Various colors, lights, and mechanisms can be employed to indicate winning combinations, jackpots, and all other information related to the game 10 thereby by making the game 10 more exciting. There are about fifty-four cards in the game 10. The game is played with the controller 22 acting dealer D, who deals the cards and represents the “house” and with players (more players can be involved to play the game without limiting the scope of the present invention) whom make the wagers. A “game” starts with no cards on the screen 20 and continues until the final card is dealt (e.g. third, fifth, or seventh card). Within the game 10, there are multiple “rounds”, which can vary from as little as three to as many as seven or more in number, as discussed in the embodiments below.

To start a game, the players place the wagers (e.g. casino chips, cash, tangible property) anywhere on the entire playing field 116. The wagers can be placed on the aforementioned sections, the players may bet, or single round wager, the individual card to come out next, they may bet it on a split (2-way), or on a corner (4-way), they may bet any suit, or color, they may bet any number, or the Jokers. Additional, wagering includes the “poker hand bets” (which can only be made prior to the first card being dealt in the full-game).

“Poker” wagers, or multi-round wagers, are preferably placed in the payout section or a poker wager area 180 and on any of the “Flush” subsection 182, the “Royal Flush” subsection 184, the “Straight Flush” subsection 186, the “Straight” subsection 188, the “5 of A Kind” subsection 190, the “4 of A Kind” subsection 192, the “3 of A Kind” subsection 194, the “Full House” subsection 196, the “Two Pairs” subsection 198, and the “One Pair” subsection 200.

Optionally, the dealer may place the wagers in the payout section 80 for the players, thus restricting access to that area of the table. The poker hand wagers, includes at least “One Pair”, “Two Pairs”, “Three of a Kind”, “Straight”, “Flush”, “Four of a Kind”, “Straight Flush”, “Royal Flush”, and “Five of a Kind”. The players make an initial wager, anywhere in the aforementioned areas on the apparatus 12 or any combination of these bets. Once these initial wagers have all been placed, the dealer takes the top card off the deck and places it face down as a “Burn Card.” A “Burn Card” serves numerous important purposes. First, this is used to completely mask the outcome card from view, disabling any marked card or potential thereof. Secondly, the burn card has the effect of tantalizing the player as to what might have been the next card (e.g. every other card in the deck instead of five cards in a row). Then the next card is flipped face up and this is the “Outcome Card”. The dealer then marks on the field the position that matches the outcome card and clears all the bets that have not won, (except the “poker hand” wagers which cannot be determined until outcome card number five is shown), then dealer pays the wins.

It is contemplated by this invention that marking the corresponding position on the field can be accomplished my many methods or marking means. In one preferred marking embodiment, marking is accomplished by the dealer placing a physical marker (e.g. a blank chip, a figurine, or the like) on the field position corresponding to the outcome card. In another preferred marking embodiment, the dealer activates a switching device that illuminates the field position or a portion thereof, corresponding to the outcome. This completes a round. The players 18 may bet the field again towards what the next outcome card will be, and the process is repeated until the fifth round and last outcome card is shown, to which wagers are cleared and paid as before and if a “poker hand” has been made from the five outcome card then the correlating “poker hand bet” marked and is paid and the rest are cleared, completing the “full-game”.

Once the entire field is cleared, a new “full-game” can begin again. In a second preferred exemplary embodiment, the players make a one-time wager, either inside the field 116, the outside the field 16, or in the poker wager area 180 or any combination of these bets. Once these one-time wagers have all been placed, the dealer takes the top card off the deck and places it face down as a “Burn Card.” Then the next card is flipped face up and this is the “Outcome Card”. The dealer then marks on the field 116 the position that matches the outcome card. The dealer then repeats the burn card, outcome card and marking steps (after the final time, dealer also marks any winning poker hand positions) until all outcome cards are showing. Only at this point, the dealer clears all the bets that have not won, and then pays the wins. This then completes a game. In a third preferred exemplary embodiment, at the first opening of betting, players may place bets in any wagering area of the table.

Anywhere in the field 116 of one card bets, (e.g. a single card bet, a two card bet, a four card or corner bet, a number or street bet, a split street bet, an any suit bet, a split suit bet, a color bet, an any number bet, an any face or ace bet, or a 3 way bet such as “One Eyed Jack or Suicide king”, or a joker with 2 aces split). Players can also place a onetime bet towards a progressive jackpot, by placing a dollar into the “Progressive Jackpot” slot to which collectively pays those players (who placed the progressive wager) in that particular series of rounds. If a Poker Hand is made, the payout from the progressive jackpot is as follows: “Five of a Kind” pays from about 50% to 100% of Jackpot, “Royal Flush” pays from about 30% to 60%, “Straight Flush” pays from about 10% to 30%, and “Four of a Kind” pays from about 5% to 10%.

Those skilled in the art will appreciate that other combination of percentages may be used and those listed above are presented for exemplary purposed without limiting the scope of the present invention of the game 10. It is also contemplated that these payout percentages can vary and may be increased or decreased at the discretion of the house. It is also contemplated that one may choose other criteria for determining payouts from the progressive jackpot. For the player to win the Poker Hand the “Progressive Jackpot” bet, the players must wait through all single card betting rounds which results in all the cards coming out (for that game) and making the Poker Hand. Note that a Joker shown as part of the shown outcome cards, counts as a wild card, or has multiple values, and only the best possible poker hand wins. After a short time, the dealer will close or stop allowing players to make bets, by stating “no more bets” or an equivalent phrase, at which time no further “poker hand bets” or “Progressive Jackpot bets” will be allowed until the next game begins. The dealer removes the first card from the card shoe or holder 14, keeping it face down, and places it in the box marked “card 1” of the section 102, this is a burn card.

Next, the dealer removes another card from the shoe and flips it up on top of the burn card in the box marked “card 1”. The value of this card is to be marked in the field 16 with the marking means, and all bets in the field that do not correlate to the card marked are cleared by removing them from the playing surface, preferably into a bin in the dealer area that will sort them by color, count them, making them ready to be placed in the dealer area again for purchase. With all losing bets cleared, the dealer goes through, and pays all winning field bets. Following the completion of payouts, the dealer removes the marking means from the field and winning players are to clear their winnings.

Once again betting for the field, except for the poker hand bets and the progressive jackpot bets, is open and betting on the outcome of card two can take place. The steps of dealing, placing, marking and paying again take place. The procedure repeats, until all outcome cards have been shown, after the final outcome card has been dealt and marked, the dealer will announce the best “Poker Hand” made, (if any) from the cards that have come out. “Poker Hands” may use either joker (or both) as wild cards, if shown, to make the best five card hand. Note that a Joker shown as part of the shown cards, it counts as a wild card and only the best possible poker hand wins. From there the dealer clears the losing poker hand bets and pays the winning bets of the correlating poker hand. Finally, if the “Poker Hand” made correlates to a win for the “progressive jackpot”, the players around the table who played the progressive for that round are paid by divided up the winning percent of the jackpot equally, if no jackpot hand is made, the players have lost, and their losing progressive bets may be added to the jackpot value for future games. The progressive jackpot can continue to accumulate value, game after game, until a player wins the pot or a portion of the pot. It is also contemplated that this progressive jackpot could be an amalgamated jackpot from any number of individual gaming tables.

Additionally, it is contemplated that these unused outcome cards could be the basis for some other kind of wager. In a fifth preferred exemplary embodiment, the game can consist of only three rounds. In this case, the outcome of the poker hand would be based only upon these three cards and poker wagers such as 4-of-a-kind and the like would obviously not be available. In one preferred aspect of the invention, the Jokers used are not black or red, but are some other colors (e.g. a BLUE Joker and a YELLOW Joker).

In another preferred aspect of the invention, the game 10 can be played with more than one deck of cards. The deck or decks of cards may be shuffled before the start of each game. The more decks of cards used, generally, the less often the cards must be shuffled. It is also contemplated that the deck of cards can be shuffled or randomized by a manual or automated process or a combination of both.] The wagering has preferred payout odds to keep the dealer or house profitable as well as keep the players excited and coming back for more. The payouts are as follows: Inner and Outer Field Bets Any Single Card (including a joker) range from about 10/to/1 to 100/to/1, preferably from less than about 60/to/1, and more preferably from less than about 47/to/1. Any Split (2 cards) range from about 10/to/1 to 50/to/1, preferably from less than about 40/to/1, and more preferably from less than about 23/to/1. Any Corner (4 cards) range from about 3/to/1 to 30/to/1, preferably from less than about 20/to/1, and more preferably from less than about 11/to/1. Any Street (any single card in any suit) range from about 2/to/1 to 30/to/1, preferably from less than about 20/to/1, and more preferably from less than about 10/to/1. Any Suit range from about 1/to/1 to 10/to/1, preferably from less than about 5/to/1, and more preferably from less than about 2/to/1. Color bet range from about 0.5/to/1 to 10/to/1, preferably from less than about 6/to/1, and more preferably from less than about 1/to/1.

Alluding to the above, any Face or Ace range from about 1/to/1 to 10/to/1, preferably from less than about 6/to/1, and more preferably from less than about 2/to/1. Any Number range from about 1/to/1 to 10/to/1, preferably from less than about 6/to/1, and more preferably from less than about 2/to/1. Suicide king/one eye jack 16 to 1 range from about 5/to/1 to 30/to/1, preferably from less than about 20/to/1, and more preferably from less than about 16/to/1. “Poker Hand” bets pair range from about 1/to/1 to 10/to/1, preferably from less than about 6/to/1, and more preferably from less than about 3/to/1. 3/kind range from about 2/to/1 to 10/to/1, preferably from less than about 6/to/1, and more preferably from less than about 5/to/1. Straight range from about 2/to/1 to 40/to/1, preferably from less than about 20/to/1, and more preferably from less than about 10/to/1. Flush range from about 3/to/1 to 80/to/1, preferably from less than about 40/to/1, and more preferably from less than about 20/to/1. 4/kind range from about 10/to/1 to 200/to/1, preferably from less than about 60/to/1, and more preferably from less than about 50/to/1.

Alluding to the above, straight Flush range from about 10/to/1 to 1000/to/1, preferably from less than about 250/to/1, and more preferably from less than about 100/to/1. Royal Flush range from about 100/to/1 to 10000/to/1, preferably from less than about 1500/to/1, and more preferably from less than about 1000/to/1. 5/Kind range from about 1000/to/1 to 25000/to/1, preferably from less than about 6000/to/1, and more preferably from less than about 5000/to/1. All of the aforementioned ranges are illustrated for exemplary purposes are not intended to limit the scope of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electronic gaming apparatus comprising a machine-readable medium having computer program code stored thereon which when executed by a machine causes said machine to perform a method of conducting an electronic game variation between users, said electronic gaming apparatus comprising:
a user interface component;
a controller of said electronic gaming apparatus performing dealer functions;
a first device to the controller to generate a first image element representing a table surface of a first color presenting a dealer section and players section;
a second device to the controller to generate a second image element representing a playfield including a plurality of sections with a first of said sections presenting several rows with each of said rows divided by cells wherein each cell present different kind of cards ranging from the card having the highest kind to the card having a lowest kind with all of said card being of a single suit allowing the players to place the bets anywhere in said sections;
a third device to the controller to generate a third image element representing a second of said sections extending from said first section presenting color identifiers allowing the players to place the bets on any of said color identifiers;
a fourth device to the controller to generate a forth image element representing a third of said sections extending from said first section presenting kind identifiers of various colors allowing the players to place the bets on any of said kind identifiers;
a fifth device to the controller to generate a fifth image element representing a fourth of said sections extending from said first section presenting a row extending in parallel relationship with said several rows of said first sections and divided into cells of said fourth section and aligned with said cells of said rows of said first sections allowing the players to place the bets on any of said cells of said fourth section;
a sixth device to the controller to generate a sixth image element representing a card section having a plurality of segment wherein the number of said segment equals to the number of gaming rounds played by the players to allow a dealer to place the cards on each of said segments;
a central processing unit operably communicated with said controller for receiving information from said first device, said second device, said third device, said fourth device, said fifth device, and said sixth device to determine correlation between said first image elements through said fifth image elements presented to the users through said user interface component; and
a software of said central processing unit configured to calculate a plurality of winning options with each of said winning options presenting different inning combination values with said wagering section allowing said controller performing de er functions to determine the winning outcome of each round as said controller performing dealer functions opens a card placed in order to each of said segments of said card section and determining a winner of a jackpot after all cards placed on each of said segments define one of said winning options presenting different of winning combination values and the other of said side presenting said first color to match with said surface, wherein said winning options are defined by Inner and Outer Field Bets Any Single Card ranging from about 10/to/1 to 10/to/1, preferably from less than about 60/to/1 and more preferably from less than about 47/to/1, any Split (2 cards) range from about 10/to/1 to 50/to/1, preferably from less than about 40/to/1, and more preferably from less than about 23/to/1, any Corner (4 cards) range from about 3/to/1 to 30/to/1, preferably from less than about 20/to/1, and more preferably from less than about 11/to/1, any Street (any single card in any suit) range from about 2/to/1 to 30/to/1, preferably from less than about 20/to/1, and more preferably from less than about 10/to/1, any Suit range from about 1/to/1 to 10/to/1, preferably from less than about 5/to/1, and more preferably from less than bout 2/to/1, color bet range from about 0.5/to/1 to 10/to/1, preferably from less than about 6/to/1, and more preferably from less than about 1/to/1, any Face or Ace range from about 1/to/1 to 10/to/1, preferably from less than about 6/to/1, and more preferably from less than about 2/to/1, any Number range from about 1/to/1 to 10/to/1, preferably from less than about 6/to/1, and more preferably from less than about 2/to/1, suicide king/one eye jack 16 to 1 range from about 5/to/1 to 30/to/1, preferably from less than about 20/to/1, and more preferably from less than about 16/to/1, “Poker Hand” bets pair range from about 1/to/1 to 10/to/1, preferably from less than about 6/to/1, and more preferably from loss than about 3/to/1. 3/kind range from about 2/to/1 to 10/to/1, preferably from less than about 6/to/1, and more preferably from less than about 5/to/1 straight range from about 2/to/1 to 40/to/1, preferably from less than about 20/to/1, and more preferably from less than about 10/to/1, flush range from about 3/to/1 to 80/to/1, preferably from less than about 40/to/1 and more preferably from less than about 20/to/1. 4/kind range from about 10/to/1 to 200/to/1, preferably from less than about 60/to/1, and more preferably from less than about 50/to/1, straight Flush range from about 10/to/1 to 1000/to/1, preferably from less than about 250/to/1, and more preferably from less than about 100/to/1, royal Flush range from about 100/to/1 to 10000/to/1, preferably from less than about 1500/to/1, and more preferably from less than about 1000/to/1, 5/Kind range from about 1000/to/1 to 25000/to/1, preferably from less than about 6000/to/1, and more preferably from less than about 5000/to/1.

2. The electronic gaming apparatus as set forth in claim 1 wherein said winning options presenting different winning combination value are further defined by “Flush”, “Royal Flush”, “Straight Flush”, “Straight”, “5 of A Kind”, “4 of A Kind”, “3 of A Kind”, “Full House”, “Two Pairs”, and “One Pair”.

3. The electronic gaming apparatus as set forth in claim 1 including a housing.

4. The electronic gaming apparatus as set forth in claim 2 wherein the number of said segment equals to five of said segment.

5. The electronic gaming apparatus as set forth in claim 1 wherein s d plurality of said sections is further defined by four rows with each of said rows presenting separate suits such as “Spade”, “Clubs”, “Diamonds”, and “Hearts” with each of said rows presenting said cells ranging from “Ace” to “2”.

6. The electronic gaming apparatus as set forth in claim 1 wherein said user interface component is further defined by a touchtone screen to make selections and play the game and a keyboard.

7. A computer program product for a mobile application for a mobile device, said computer program product comprising computer-readable program code, said computer-readable program code executing in a tangible memory medium and configured to perform an electronic game; said computer program product comprising:
a user interface component;
a controller of said electronic gaming apparatus performing dealer functions;
a first device to the controller to generate a first image element representing a table surface of a first color presenting a dealer section and players section;
a second device to the controller to generate a second image element representing a playfield including a plurality of sections with a first of said ections presenting several rows with each of said rows divided by cells wherein each cell present different kind of cards ranging from the card having the highest kind to the card having a lowest kind with all of said card being of a single suit allowing the players to place the bets anywhere in said sections;
a third device to the controller to generate a third image element representing as second of said sections extending from said first section presenting color identifiers allowing the players to place the bets on any of said color identifiers;
a fourth device to the controller to generate a forth image element representing a third of said sections extending from said first section presenting kind identifiers of various colors allowing the players to place the bets on any of said kind identifiers;
a fifth device to the controller to generate a fifth image element representing a fourth of said sections extending from said first section presenting a row extending in parallel relationship with said several rows of said first sections and divided into cells of said fourth section and aligned with said cells of said rows of said first sections allowing the players to place the bets on any of said cells of said fourth section;
a sixth device to the controller to generate a sixth image element representing a card section having a plurality of segment wherein the number of said segment equals to the number of gaming rounds played by the players to allow a dealer to place the cards on each of said segments;
a central processing unit operably communicated with said controller for receiving information from said first device, said second device, said third device, said fourth device, said fifth device, and said sixth device to determine correlation between said first image elements through said fifth image elements presented to the users through said user interface component; and
a software of said central processing unit configured to calculate a plurality of winning options with each of said winning options presenting different winning combination values with said wagering section allowing said controller performing dealer functions to determine the winning outcome of each round as said controller performing dealer functions opens a card placed in order to each of said segments of said card section and determining a winner of a jackpot after all cards placed on each of said segments define one of said winning options presenting different of winning combination values and the other of said side presenting said first color to match with said surface, wherein said winning options are defined by Inner and Outer Field Bets Any Single Card ranging from about 10/to/1 to 10/to/1, preferably from less than about 60/to/1, and more preferably from less than about 47/to/1 any Split (2 cards) range from about 10/to/1 to 50/to/1, preferably from less than about 40/to/1, and more preferably from less than about 23/to/1, any Corner (4 cards) range from about 3/to/1 to 30/to/1, preferably from less than about 20/to/1, and more preferably from less than about 11/to/1, any Street (any single card in any suit) range from about 2/to/1 to 30/to/1, preferably from less than about 20/to/1, and more preferably from less than about 10/to/1, any Suit range from about 1/to/1 to 10/to/1, preferably from less than about 5/to/1, and more preferably from less than bout 2/to/1, color bet range from about 0.5/to/1 to 10/to/1, preferably from less than about 6/to/1, and more preferably from less than about 1/to/1, any Face or Ace range from about 1/to/1 to 10/to/1, preferably from less than about 6/to/1, and more preferably from less than about 2/to/1, any Number range from about 1/to/1 to 10/to/1, preferably from less than about 6/to/1, and more preferably from less than about 2/to/1, suicide king/one eye jack 16 to 1 range from about 5/to/1 to 30/to/1, preferably from less than about 20/to/1, and more preferably from less than about 16/to/1, “Poker Hand” bets pair range from about 1/to/1 to 10/to/1 preferably from less than about 6/to/1, and more preferably from less than about 3/to/1. 3/kind range from about 2/to/1 to 10/to/1, preferably from less than about 6/to/1 and more preferably from less than about 5/to/1, straight range from about 2/to/1 to 40/to/1, preferably from less than about 20/to/1, and more preferably from less than about 10/to/1, flush range from about 3/to/1 to 80/to/1, preferably from less than about 40/to/1, and more preferably from less than about 20/to/1. 4/kind range from about 10/to/1 to 200/to/1, preferably from less than about 60/to/1, and more preferably from less than about 50/to/1, straight Flush range from about 10/to/1 to 1000/to/1, preferably from less than about 250/to/1, and more preferably from less than about 100/to/1, royal Flush range from about 100/to/1 to 10000/to/1, preferably from less than about 1500/to/1, and more preferably from less than about 1000/to/1, 5/Kind range from about 1000/to/1 to 25000/to/1, preferably from less than about 6000/to/1, and more preferably from less than about 5000/to/1.

8. The computer program product for the m bile application as set forth in claim 7, wherein said winning options presenting different winning combination values are further defined by “Flush”, “Royal Flush”, “Straight Flush”, “Straight”, “5 of A Kind”, “4 of A Kind”, “3 of A Kind”, “Full House”, “Two Pairs”, and “One Pair”.

9. The computer program product for the mobile application as set forth in claim 7, wherein said mechanical device is further defined by a pair of rollers and a strip entrained about said rollers to define two faces with one presenting a surface having aid first color to match with said first color of said table surface and another of said faces presenting graphical representation of sections defined by “Flush”, “Royal Flush”, “Straight Flush”, “Straight”, “5 of A Kind”, “4 of A Kind”, “3 of A Kind”, “Full House”, “Two Pairs”, and “One Pair”, wherein said rollers are rotated to move strip between said first gaming mode and said second gaming mode.

10. The computer program product for the mobile application as set forth in claim 7, wherein the number of said segments equals to five of sa d segments.

11. The computer program product for the mobile application as set forth in claim 7, wherein said plurality of said sections is further defined by four rows with each of said rows presenting separate suits such as “Spade”, “Clubs”, “Diamonds”, and “Hearts” with each of said rows presenting said cells ranging from “Ace” to “2”.
